(19) United States
(12) Patent Application Publication
(10) Pub. No.: US 2015/0278064 A1
(43) Pub. Date: Oct. 1, 2015

(54) SIGNAL EXPORT FROM ON-CHIP CIRCUIT

(71) Applicant: CIGOL DIGITAL SYSTEMS LTD., Yokneam, IL (US)

(72) Inventors: Nadav Cohen, Yavne (IL); Gilad Cohen, Rehovot (IL)

(73) Assignee: CIGOL DIGITAL SYSTEMS LTD., Yokneam, IL (US)

(21) Appl. No.: 14/226,853

(22) Filed: Mar. 27, 2014

(51) Int. Cl. G06F 11/34; G06F 11/30

(52) U.S. Cl. CPC G06F 11/348; G06F 11/3065

(57) ABSTRACT

Data is collected from one or more collection points on a chip, stored in a buffer and exported from the chip by an export circuit. The export circuit operates in two different modes. In a first mode, referred to as a best effort mode, the export circuit transmits data from the buffer outside the chip when possible and discards data when required to keep the occupancy of the buffer within desired limits. In a second more, referred to as an event mode and operated upon receiving an indication of occurrence of an event in the chip, the export circuit exports all the data in the buffer, belonging to an event window, to outside the chip. In some embodiments, upon completion of the export of the event window, the export circuit returns to the best effort mode.

### FIELD OF THE INVENTION

The present invention relates generally to integrated circuits and particularly to export of signals from integrated circuits.

### BACKGROUND OF THE INVENTION

Integrated circuits, referred to also as chips, have become very complex, sometimes including millions of transistors in a single integrated circuit (IC). Often, ICs process much more data than can possibly be input and output through device input/output (I/O) pins. In order to perform tasks, such as debugging, monitoring, maintenance and/or support, it is desired to collect trace information from various points in the integrated circuit. The trace information is collected in a buffer in the integrated circuit and needs to be exported from the integrated circuit for external analysis. The size of the buffer and the amount of bandwidth allocated for export of trace information is limited, and therefore the amount of trace information that can be exported is limited. Therefore, standard debug systems only export on-chip trace data that is indicated by a triggering event. The data may be collected continuously in a buffer until a stop-triggering is generated or the accumulation of trace data may begin in response to a start-triggering.

U.S. Pat. No. 8,589,745 to Zhong et al. describes a trace buffer for an on-die logic analyzer, which collects trace data based on triggers and includes separate storage spaces for trace data from separate data sources.

US patent publication 2013/0156146 to Hutchings et al. describes a configurable trigger circuit for an integrated circuit, which supports storing selected signals at multiple time windows revolving around events of interest in an on-chip trace buffer.

US patent publication 2011/0202801 to Horley et al. describes a memory mapped trace output device that operates with different priorities for different addresses. When trace data is written for output, its priority is determined and accordingly it is written to an address range associated with that priority. The trace output device operates on the data in the different address ranges according to their respective priorities. In particular, data written to the highest priority address range is either accepted and processed or it is stalled until it can be processed, whereas data written to a lower priority address range is always accepted and is discarded if it cannot be processed

### SUMMARY

Embodiments of the present invention that are described hereinbelow provide methods and systems for exporting trace information from an integrated circuit.

There is therefore provided in accordance with an embodiment of the present invention, a method of managing on-chip data, comprising collecting data from one or more collection points on a chip, storing the collected data in a buffer, operating an export circuit in a best effort mode in which data from the buffer is transmitted outside the chip when possible and data from the buffer is discarded when required to keep the occupancy of the buffer within desired limits, receiving an indication of occurrence of an event in the chip and operating the export circuit in an event mode in which all the data in the buffer, belonging to an event window, is transmitted to outside the chip, responsively to the received indication.

Optionally, collecting the data comprises collecting signals at an operation rate of the chip. Optionally, storing the data comprises storing the data in blocks of a plurality of different sizes and/or with respective headers indicating priorities of the blocks. Optionally, operating the export circuit in a best effort mode comprises repeatedly considering an oldest block of data in the buffer and determining whether to transmit or discard the block at least partially based on one or more attributes of the block.

Optionally, determining whether to transmit or discard the block comprises determining within a predetermined number of clock cycles, whether to transmit or discard the block. Optionally, determining whether to transmit or discard the block comprises determining whether to transmit or discard the block, before considering a subsequent block. Optionally, determining whether to transmit or discard the block comprises postponing the decision for one or more of the considered blocks. Optionally, determining whether to transmit or discard the block at least partially based on one or more attributes of the block comprises determining without considering attributes of other blocks in the buffer. Optionally, determining whether to transmit or discard the block at least partially based on one or more attributes of the block comprises determining at least partially based on the current occupancy of the buffer and/or the current available bandwidth for transmission of blocks from the buffer.

Optionally, determining whether to transmit or discard the block comprises determining while taking into account the priority of the collection point of the data contained in the block.

Optionally, operating the export circuit in a best effort mode comprises maintaining the occupancy of the buffer at least at a minimal level, such that a data block from the buffer is not discarded before a predetermined amount of data entered the buffer after the block. In some embodiments, the minimal level is user configurable.

Optionally, operating the export circuit in a best effort mode comprises maintaining the occupancy of the buffer lower than a maximal level, such that in case an event of interest occurs, the buffer will be able to store enough data after the event, even if blocks are not dequeued from the buffer. In some embodiments, the maximal level is user configurable.

Optionally, collecting the data comprises collecting trace data.

Optionally, the data in the buffer belonging to the event window comprises all the data in the buffer at the time of the occurrence of the event.

Optionally, the data in the buffer belonging to the event window comprises data collected in the buffer after the occurrence of the event, of an amount of an empty area of the buffer at the time the event occurred.

Optionally, the method includes repeating the operating of the export circuit in the best effort mode after the data in the buffer belonging to the event window, is transmitted to outside the chip.

Optionally, the method includes generating a notification when the occupancy of the buffer returns to within the desired limits, after moving from the event mode to the best effort mode.

There is further provided in accordance with an embodiment of the present invention, a method of managing on-chip trace data, comprising collecting trace data from one or more collection points on an integrated circuit chip, storing blocks of the collected trace data in a buffer; and operating an export circuit to repeatedly consider blocks in the buffer, to determine whether to transmit or discard the considered block. The considered blocks are not discarded before a predetermined amount of data entered the buffer after the considered block.

Optionally, blocks in the buffer are not considered before a predetermined amount of data entered the buffer after the block to be considered. Optionally, storing the trace data blocks comprises storing the data in blocks of a plurality of different sizes. Optionally, operating the export circuit comprises determining for each block whether to transmit or discard the block based on the occupancy of the buffer and at least one attribute of the block.

Optionally, determining for each block whether to transmit or discard the block comprises determining at least partially based on an estimate of the available transmission bandwidth.

There is further provided in accordance with an embodiment of the present invention, a trace management unit on an integrated circuit, comprising a buffer in which trace data blocks are accumulated, a trace collection unit configured to collect and store trace data blocks in the buffer; and an export unit configured to repeatedly determine a data block to be currently handled, to determine whether to export or drop the determined currently handled data block at least partially responsively to its respective priority and to export data blocks determined to be exported. The export unit is configured not to discard a handled block before a predetermined amount of data entered the buffer after the handled block.

Optionally, the trace collection unit is configured to store in the buffer data blocks of different sizes. Optionally, the buffer comprises a first-in first-out buffer, a pointer which is continually updated to point to the data block which is in the buffer for a longest period and a pointer which is continually updated to point to the first empty location in the buffer. Optionally, the export unit is configured to repeatedly determine a data block which is in the buffer for a longest period to be the currently handled data block. Optionally, the export unit is configured to determine whether to export or drop the determined currently handled data block, at least partially responsively to a current occupancy of the buffer. Optionally, the export unit is configured to determine whether to export or drop the determined currently handled data block, at least partially responsively to a current availability of bandwidth for export of data blocks from the buffer.

There is further provided in accordance with an embodiment of the present invention, a trace management unit on an integrated circuit, comprising a buffer in which trace data blocks are accumulated, a trace collection unit configured to collect and store trace data blocks in the buffer, and an export unit configured to export data blocks from the buffer and to provide a notification when an occupancy of the buffer is within desired limits.

Optionally, the trace collection unit is configured to store in the buffer data blocks of different sizes.

### BRIEF DESCRIPTION OF THE DRAWINGS

FIG. 1 is a schematic block diagram of an integrated circuit chip analysis system, in accordance with an embodiment of the invention;

FIG. 2 is a schematic illustration of a buffer and a buffer manager, in accordance with an embodiment of the invention; and

FIG. 3 is a flowchart of acts performed by an exporter circuit, in accordance with an embodiment of the invention.

### DETAILED DESCRIPTION OF EMBODIMENTS

An aspect of some embodiments of the invention relates to a method of collecting and exporting signals from an on-chip buffer. The signals are exported from the buffer in accordance with a, possibly prioritized, best-effort approach absent an event of interest, while preserving sufficient data and/or space in the buffer such that in case an event trigger is received, the entire signals relating to the event can be buffered and exported from the on-chip buffer. This dual mode operation allows for providing signals related to an event of interest and in addition utilizing the available chip export bandwidth for signals collected at other times when an event has not occurred.

In some embodiments of the invention, the collected signals comprise internal waveforms which are collected from one or more units of an on-chip target circuit, in order to understand the internal operation of the units, for debugging, maintenance, monitoring, service, support, anomaly detection, security analysis and/or any other applicable task. Optionally, the signals are collected at high rates, optionally at the clock-operation-rate of the target circuit. Generally, the internal waveforms are signals that do not require export in order for the chip to perform its intended task. In some embodiments, the collected internal waveforms comprise state-machine controls, interconnect controls, interconnect data lines, processor memory access buses, arithmetic pipeline intermediate registers, and/or cache controls.

An aspect of some embodiments of the invention relates to a method of collecting and exporting signals in which signal data is stored in one or more on-chip buffers for at least a minimal predetermined period and thereafter an export unit considers blocks of the data and determines for each block whether to export or discard the block. Determining whether to export the data after a minimal predetermined period, rather than immediately at the time of data collection, allows for considering events occurring after the data collection, in deciding whether to export the data.

In some embodiments, the data is collected in a single buffer. Optionally, the export unit considers the blocks according to the order in which they were placed in the buffer, and determines for each considered block whether it is exported or discarded, before considering a subsequent block. Optionally, in deciding whether to export or discard a current block, the export unit, for simplicity, does not consider information about other blocks in the buffer.

Optionally, the data blocks stored in the buffer have a plurality of different priority level rankings. The export unit repeatedly determines for the oldest block in the buffer whether the block is to be exported or discarded responsive to the priority of the block and the current amount of bandwidth for data export. In some embodiments, the decision of whether to export or discard the current oldest block also depends on the occupancy level of the buffer. Optionally, the exporting includes blocks of all priority levels, although preference is given to blocks of higher priority levels.

In some embodiments, the priority levels of the data blocks are assigned according to respective collection points of the signals. Optionally, each collection point has a different unique priority level. Alternatively, several collection points may be assigned the same priority level. Alternatively or additionally, the priority levels may depend on time. For example, a user may indicate times of high priority, such as the beginning or end of operation, and/or times of low priority. In some embodiments, the priority levels are assigned based on time proximity to events of interest occurring in the chip. Optionally, the priority increases as the number of clock cycles between the respective signal collection and the event of interest decreases. Alternatively or additionally, the priority levels are a function of a physical proximity to a location of a recent event of interest. Optionally, in accordance with this alternative, an event occurring in the chip is associated with an occurrence location, and the priorities of collected signals are functions of their physical distance from the occurrence location.

In some embodiments, data blocks in the buffer for less than a predetermined period are not discarded, in case an event occurs and the blocks will be considered important for analysis of the event, in which case they must be exported.

When the export unit considers whether to export a block, the export unit optionally makes an immediate decision, either to export or drop the block, in order to rapidly move on to the next block. Alternatively, the export unit may decide, in specific cases, to wait for a given period, until sufficient information is available to make a skilled decision.

System overview

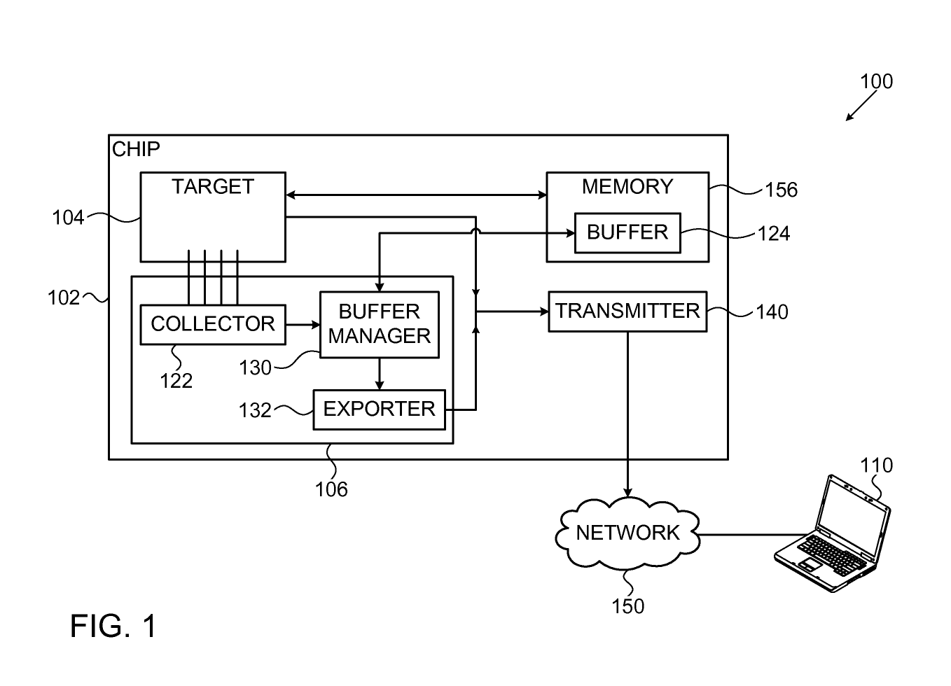

FIG. 1 is a schematic block diagram of an integrated circuit chip analysis system 100, in accordance with an embodiment of the invention. System 100 includes an integrated circuit chip 102 including a target circuit 104 from which trace data is to be exported, for debugging, maintenance, monitoring, service, support, anomaly detection, security analysis and/or any other applicable task.

In order to facilitate trace data export, a trace data management unit 106 is provided on integrated circuit chip 102 along with the target circuit 104, which performs the intended tasks of chip 102. It is noted that the elements of system 100 and particularly of chip 102 are not shown to scale and that generally, target circuit 104 occupies a larger area of chip 102 than trace data management unit 106, possibly having an area 10 times, 50 times or even 200 times greater than the area of trace data management unit 106.

Trace data management unit 106 includes a collector 122 which collects trace data from target circuit 104 and a buffer manager 130 which stores the collected trace data in blocks in a buffer 124. Trace data management unit 106 further includes an exporter 132, configured to examine data blocks in buffer 124, determine whether the blocks should be exported or dropped, and for data blocks to be exported, exports the data blocks from chip 102, for example via a transmitter 140. The exported data blocks are transmitted to a computer 110 for analysis, storage or presentation to a human user, directly, or through a network 150. Network 150 is of any suitable type and may be private or public, passing on wired and/or wireless medium. The exporting may be made to remote sites distanced from chip 102 by more than a hundred meters or kilometers, or may be to a very close unit, such as an on board DRAM or other memory, in which the exported signals are stored until they are collected for later analysis. Optionally, instead of a single computer 110, the analysis may be performed in a processing cloud or in any other suitable manner.

### Collector

Collector 122 optionally collects signal samples from one or more points of interest in target circuit 104. The points of interest are optionally indicated by a human user at the time of design of integrated circuit chip 102 and/or are selected from a plurality of available points during set-up or operation of the chip. The collection points are located, for example, on control and/or data lines of interest, depending on a specific analysis task that the operator wants to perform. Collector 122 is optionally configured to collect signals from a plurality of points, for example from at least 6, at least 20, at least 100 or even at least 200 different points. The blocks generated by collector 122 optionally each include data from a single collection point. Alternatively, some or all of the blocks multiplex data from a plurality of collection points, possibly from at least 4 points or even from all the points. Collector 122 optionally samples the signals at the operation rate of the chip, for example at a rate of at least 1 MHz, at least 500 MHz or even at least 1000 MHz. Collector 122 operates, for example as described in any of the embodiments of PCT publication WO 2012/164452, US patent publication 2012/0011411, U.S. Pat. No. 7,882,465 to Li et al. or U.S. Pat. No. 7,533,315 to Han et al., the disclosures of which are incorporated herein by reference in their entirety.

In some embodiments, collector 122 collects software trace information, such as described in any of the embodiments of US patent publication 2011/0202801 to Horley et al., US patent publication 2008/0126871 to Nardini et al. and/or U.S. Pat. No. 6,675,284 to Warren, the disclosures of which are incorporated herein by reference in their entirety.

In some embodiments of the invention, collector 122 compresses the signals before they are stored in buffer 124, for example using any of the methods described in PCT publication WO2013/136248 to Cigol Digital Systems, U.S. Pat. No. 6,985,848 to Swoboda et al., U.S. Pat. No. 8,099,273 to Selvidge et al., U.S. Pat. No. 7,814,444 to Wohl et al. and/or U.S. Pat. No. 6,950,974 to Wohl et al., the disclosures of which are incorporated herein by reference in their entirety.

Optionally, collector 122 assigns a priority rating to each data block, as discussed hereinbelow.

### Transmitter

As shown in FIG. 1, transmitter 140 is not part of trace data management unit 106, but rather is used by both target circuit 104 and trace data management unit 106. In some embodiments, trace data management unit 106 uses the available bandwidth not used by target circuit 104. Accordingly, trace data management unit 106 does not have any guaranteed bandwidth, but rather only uses bandwidth not required by target circuit 104. In some embodiments of the invention, trace data management unit 106 does not have any information about future use of bandwidth by target circuit 104 and therefore cannot predict how much bandwidth it will be able to use for exporting blocks from buffer 124 in the future. In other embodiments, trace data management unit 106 receives from target circuit 104, information on its bandwidth usage pattern, and accordingly can estimate the bandwidth it will have in the near future. Alternatively or additionally, the bandwidth usage by target 104 changes generally smoothly, such that future bandwidth can be estimated based on current bandwidth usage.

In other embodiments, the bandwidth of transmitter 140 is shared between target circuit 104 and trace data management unit 106, for example promising trace data management unit 106 a minimal percentage of the bandwidth. In still other embodiments, trace data management unit 106 has a dedicated transmitter not shared with target circuit 104. Transmitter 140 optionally transmits the data in packets, for example in MAC and/or IP packets and/or in accordance with any other suitable transmission protocol.

### Buffer

In some embodiments of the invention, buffer 124 is located within a memory 156 of chip 102, which is shared by target circuit 104 and trace data management unit 106. In other embodiments, buffer 124 is located in a separate memory unit used solely by trace data management unit 106. Optionally, memory 156 resides outside chip 102 and comprises a synchronous double data rate (DDR) dynamic random access memory (DRAM), although other suitable off-chip memory units may be used, such as an SRAM. Alternatively, any suitable on-chip memory may be used.

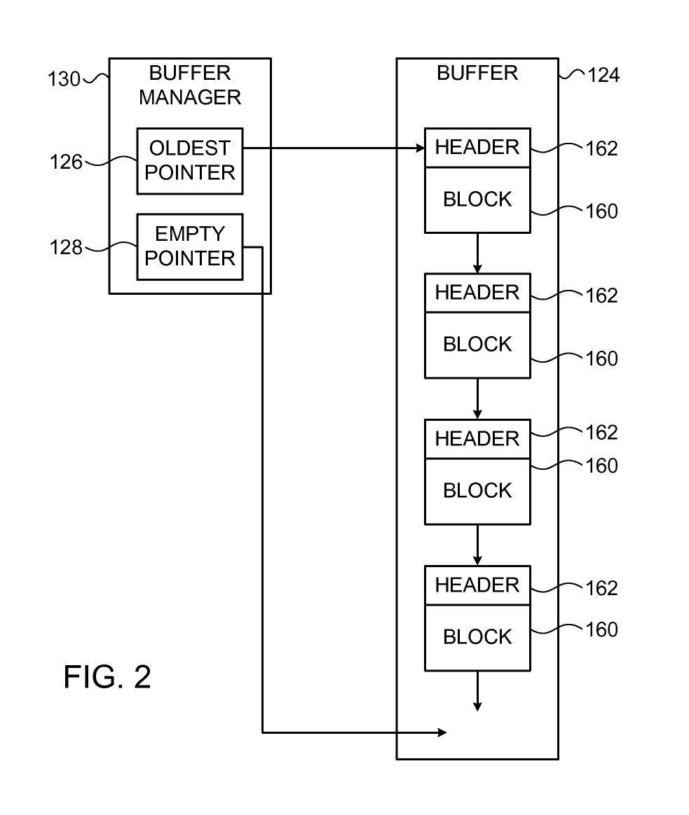

FIG. 2 is a schematic illustration of buffer 124 and buffer manager 130, in accordance with an embodiment of the invention. Data is stored in buffer 124 in blocks 160. Optionally, each block is stored in buffer 124 with a header 162 indicating its length or with a pointer to the end of the block. In some embodiments, the header 162 also includes a priority indication, which indicates the importance of the data in the block. Optionally, when collector 122 collects data from different points in target circuit 104, the priorities of the blocks are assigned according to the importance of the collection points from which their data is collected. Alternatively or additionally, the priority depends on the acquisition time of the signals and/or on other attributes. In some embodiments, target circuit 104 manages a global priority flag which is changed over time depending on the circuit conditions, and to each generated block, collector 122 assigns the priority of the global flag. The value of the global flag may change based on time and/or one or more internal values of target circuit 104. In some embodiments, an on-chip CPU in target circuit 104 controls the global priority flag according to system-level events. The use of a CPU allows a user to easily configure in software or firmware the conditions for setting the global priority flag. For example, when the CPU in target circuit 104 executes a sensitive function as defined by a user, it may increase the value of the priority flag. In other embodiments, the value of the priority flag is adjusted according to indications received from exporter 132, for example according to the percentage of blocks being dropped. Alternatively to a single global flag, target circuit 104 may manage several priority flags, possibly a priority flag for each collection point or each zone or type of collection points. For example, collection points of control signals may be assigned one flag and collection points of data signals a different flag.

In some embodiments, a binary priority field is used, allowing only two levels of priority. In other embodiments, a multi-level priority of at least 4, at least 8 or even at least 15 priority levels, is used.

In some embodiments, trace data management unit 106 controls the priority flag(s), for example according to a user-configured predefined policy.

The data is optionally stored in buffer 124 in blocks 160 of variable sizes, for example due to the signals being compressed with variable compression ratios. Optionally, the blocks may be as small as 256 bits or smaller and as big as 100 kBits or larger or even larger than 1 Mbit. The data in each block 160 is optionally usable only if provided entirely, for example due to encoding or encryption. Optionally, some blocks may contain only the header without any payload data, in which case the header may contain a flag indicating how to reconstruct the payload data during later analysis.

Optionally, buffer manager 130 manages buffer 124 with a pair of pointers: an oldest pointer 126, which is configured to point to the block remaining in buffer 124 for a longest period, and an empty pointer 128 configured to point to the first empty location in buffer 124. Buffer 124 is optionally organized as a cyclical first-in-first-out (FIFO) buffer. Data blocks are stored in buffer 124 at a point identified by empty pointer 128, and an oldest pointer 126 continuously points at the oldest data block in the buffer. Collector 122 optionally writes each block it prepares to the position indicated by empty pointer 128. Optionally, when signals are collected from several collection points at the same time, their blocks are written into buffer 124 in a predetermined, possibly arbitrary, order. Alternatively, the order may depend on the relative known or estimated priorities of the collection points, optionally first writing in the buffer 124 data from more important collection points. Optionally, if the buffer is full, the block is dropped. Alternatively, if the buffer is full, collector 122 stalls the operation of target circuit 104 until there is sufficient room in buffer 124, due to export and/or dropping of some of the data blocks in the buffer. In some embodiments of the invention, the setting of the operation of collector 122 when buffer 124 is full is user configurable.

Buffer 124 is optionally sufficiently large, so that it can store trace data collected over a long period of time, for example more than a second or even more than a minute. In some embodiments of the invention, buffer 124 has a capacity of at least 100 Kbytes, at least 1 Mbyte or even at least 100 Mbytes or 1 GByte. On the other hand, in some embodiments, buffer 124 may be relatively small, possibly having a capacity of less than 100 Kbytes, less than 10 Kbytes or even less than 4 Kbytes. In such cases, buffer 124 may have room for no more than 10 blocks or even no more than 5 or 4 blocks. Optionally, the buffer size used by trace data management unit 106 is user configurable.

### Exporter

Optionally, all the data collected by collector 122 is written to buffer 124, and is stored therein for at least a first predetermined period, in case an event requiring analysis occurs. In some embodiments of the invention, exporter 132 is configured to operate in a plurality of different modes. Absent any special event, exporter 132 optionally operates in a best effort mode, in which blocks are transmitted when possible and are dropped when the occupancy of buffer 124 is too large. It is noted, however, that exporter 132 does not drop data blocks for which the first predetermined period since they were stored in buffer 124 or since they were collected, has not passed.

When an indication that an event occurred is received, exporter 132 optionally operates in an event window mode in which all the data in the buffer 124 is exported, from the first predetermined period before the event until a second predetermined period after the event. In some embodiments of the invention, the lengths of the first and second predetermined periods are configured at the time of production of chip 102 and cannot be changed by a user. Alternatively, the lengths of the first and second predetermined periods are user configurable, within limits defined by the size of buffer 124. In some embodiments, also the size of buffer 124 is configurable. In some embodiments, the first and second periods are of equal lengths. In other embodiments, the first period is longer than the second period, possibly 50% longer or even 100% longer, so as to provide the user more information about the operation of target circuit 104 before the event occurred. In still other embodiments, the first period is shorter than the second period, possibly 20% or even 50% shorter, providing the user with information with an emphasis on the effects of the event. It is noted that in some embodiments, the user may choose to use only the first period or only the second period, setting the length of the other period to zero.

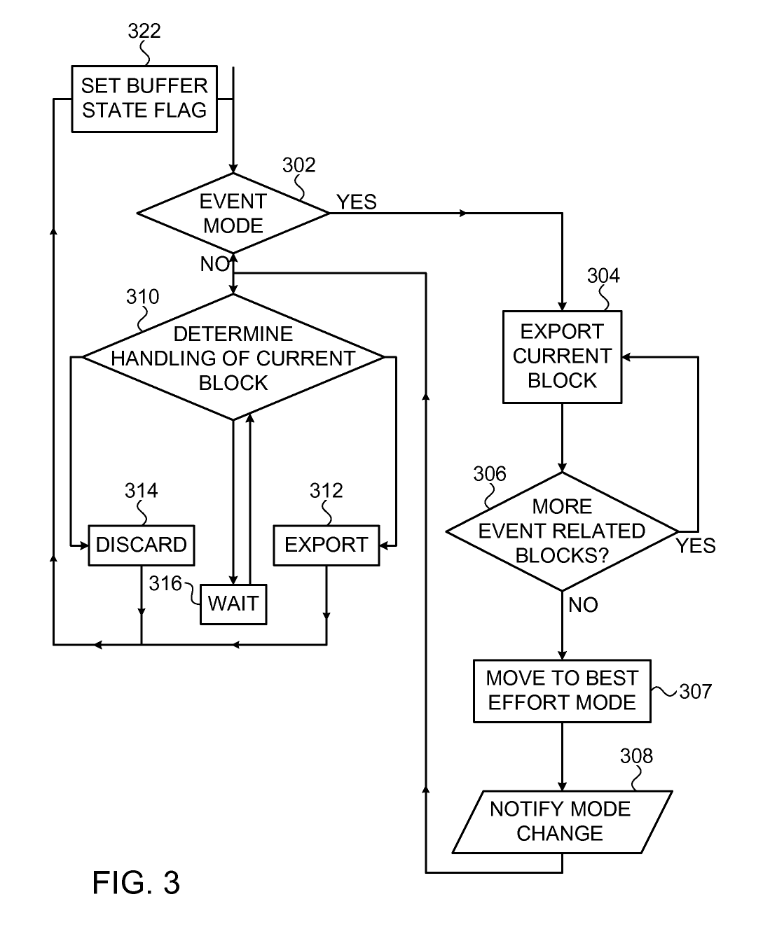

FIG. 3 is a flowchart of acts performed by exporter 132, in accordance with an embodiment of the invention. When (302) in the event window mode, exporter 132 repeatedly exports (304) the block pointed at by oldest pointer 126 based on the available bandwidth, without dropping any blocks, until (306) all the blocks from the first and second predetermined periods, which are referred to herein as event related blocks, have been exported. Thereafter, exporter 132 moves (307) to operate in the best effort mode, and optionally provides (308) a user notification that the operation mode has changed. In the best effort mode, exporter 132 accesses the header of the block pointed at by oldest pointer 126 and determines (310) whether to export (312) or discard (314) the block. In some embodiments, the determination (310) may also result in waiting (316) a short time without exporting or dropping the block and repeating the determination (310) of how to handle the block (e.g., export, discard, or wait again) based on the conditions at the latter determination time point.

If the current block is determined to be exported, exporter 132 actuates the transmission of the block. If, however, exporter 132 decides to discard (314) the current data block, the area of the buffer carrying the data block is marked as free and oldest pointer 126 is updated to point to the next block in buffer 124. Exporter 132 then handles the next block.

The determination (310) of whether to export (312), drop (314) or wait (316) is optionally based on the occupancy of buffer 124, as determined, for example, from the distance between oldest pointer 126 and empty pointer 128. Optionally, exporter 132 is designed, in the best effort mode, to preserve the occupancy of buffer 124 at or above a first level corresponding to the first predetermined period, such that when an event of importance is declared, buffer 124 carries data from a period of the length of the first predetermined period before the event occurred. In some embodiments, exporter 132 is also designed, in the best effort mode, to preserve the occupancy of buffer 124 at or below a second level corresponding to the second predetermined period, such that when an event occurs and collector 122 begins to write data to buffer 124 for the second predetermined period, there is enough room to store the collected data in buffer 124 even under the condition that exporter 132 is not dropping data. Optionally, the second level is set such that there is enough room to store the data collected in the second period, even if there is no available bandwidth for transmission. Alternatively, the second level is set such that there is enough room to store the data collected in the second period assuming exporter 132 is exporting data at an average rate during the second period after the event.

In some embodiments, the first and second levels are very close, or even at the same point, such that the size of buffer 124 is about the size required to store the data from the first and second predetermined periods around an event.

Optionally, when the occupancy of buffer 124 is substantially higher than the second level, the current block is dropped, even if it can be transmitted within a given time. The block is dropped in order to save the given time for transmission of subsequent blocks and free room in the buffer as fast as possible in case an event state is declared and the missing space is needed. If the occupancy of buffer 124 is above the second level by a lower extent, exporter 132 exports the current block if it is expected to require less than a predetermined amount of time and otherwise drops the block. When the occupancy of buffer 124 is below the second level, exporter 132 optionally always exports the block, even if the current transmission rate is very low.

The time required to transmit the current block is optionally estimated based on an estimated bandwidth for the near future (e.g., the current available bandwidth) and the size of the current block. Alternatively to taking the length of the current block into account in the determination (310), the length of the block is not checked by exporter 132 and is not considered in deciding whether to export the block. It is noted that instead of estimating the time required to transmit the current block, exporter 132 may estimate any other suitable corresponding measure, such as the extent to which the occupancy of the buffer will change if the block is transmitted versus the extent if the block is discarded. In some embodiments of the invention, in estimating the change in the occupancy, the rate at which data is added to the buffer is taken into account. In other embodiments, the rate at which data is added to the buffer is not taken into account and exporter 132 takes into account only the data currently in the buffer.

In some embodiments of the invention, exporter 132 includes a random factor in determining for each specific block whether it is exported or discarded.

A configurable threshold optionally defines when the occupancy is substantially higher than the second level. In some embodiments of the invention, rather than having a single threshold, each priority is assigned a different threshold, such that blocks of higher priority, for which the threshold will generally be higher, will have a higher chance of being exported.

In some embodiments, the buffer occupancy after the transmission of the current block is estimated according to the current buffer occupancy, the estimated transmission rate and the estimated rate in which data is added to the buffer. In one embodiment, each block can belong to one of three priority levels. When a highest priority block is handled, the block will be dropped if the estimated buffer occupancy after transmission of the block is at least 10% above the second level. For a medium priority block, the block will be dropped if the estimated buffer occupancy after transmission is at least 5% above the second level, and a lowest priority block will be discarded if the estimated buffer occupancy after transmission is above the second level to any extent.

Exporter 132 optionally makes the decision for each current block without looking at the information (e.g., priority, size) of subsequent blocks in buffer 124. In this manner, the operation of exporter 132 is relatively simple. Alternatively, in order to make a more accurate decision, exporter 132 looks ahead at one or more following blocks, possibly at least five or even at least ten subsequent blocks. The priorities and/or lengths of the subsequent blocks are optionally used in determining whether to transmit or discard the current block. For example, in some cases the present block may be transmitted if there are no known subsequent blocks with higher priority, and dropped if there is a known subsequent block with higher priority.

Optionally, when in the best effort mode, exporter 132 periodically determines whether the buffer occupancy is between the first and second levels and accordingly sets (322) a buffer state flag which indicates whether the buffer is ready for moving into the event mode. Optionally, the determination is performed after handling of every block or every predetermined number of blocks. Alternatively, the determination is performed in parallel to the operation of exporter 132, by a separate unit. In some embodiments, the determination is performed only after moving (307) from the event mode to the best effort mode, as after being in the event mode the buffer may be substantially out of the range of the first and second limits.

In some embodiments of the invention, collector 122 writes data to buffer 124 at a rate substantially higher (e.g., at least 50%, at least 100%, at least 200%, at least 1000%, or even at least 10000% or higher) than the average rate at which data is exported by transmitter 140. Possibly, collector 122 writes data to buffer 124 at a rate substantially larger than the maximal rate at which data from buffer 124 is exported by transmitter 140. Accordingly, data in buffer 124 will be regularly dropped. The purpose of storing the data is to allow for cases in which an event occurs and the data will be required. In some embodiments, collector 122 is configured to collect into buffer 124 substantially more data than can be exported by exporter 132 on the average, such that at least 50%, at least 70% or even at least 90% of the data and/or blocks stored in buffer 124 is discarded.

The determination of whether (310) to export or discard the current block, is optionally performed in a very quick process, for example requiring less than 100, less than 50, less than 20 clock cycles or even a single clock cycle at the operation rate of target circuit 104.

Although the above description relates to using a single buffer to store all the collected signals, in other embodiments of the invention a plurality of buffers are used for signals collected from different points and/or for signals of different priorities. Exporter 132 optionally keeps track of the occupancy of each of the buffers and accordingly determines which blocks to export and which to drop. In some embodiments, each time a next block for transmission needs to be selected, exporter 132 selects the block with the highest priority. In parallel, when a buffer is full or close to full, one or more blocks from the buffer are discarded in order to make room for newer data. In other embodiments, exporter 132 manages for each buffer an urgency score, indicating the importance of exporting a block from the buffer, based on the priority of the buffer and its occupancy.

### CONCLUSION

The methods of the above described embodiments may be used in various stages of integrated circuit development and utilization, including design stages before commercial production, testing (e.g., for quality assurance) after commercial production and field testing and trouble shooting after the integrated circuit is supplied to a customer. Other applications of the above methods may be non-intrusive internal performance measurements of at least one deployed chip, at least a thousand deployed chips, or even at least a million deployed chips. Another application of the above methods is firmware cyber-security cycle-accurate real-time inspection. Optionally, trace data management unit 106 is implemented in a small area of chip 102, allowing for including an instance, or even multiple instances, of trace data management unit 106 in the integrated circuit provided to the end customer.

It is noted that reference in the above description to a determination of whether a block is exported or discarded relates, when applicable, both to embodiments in which there are only two possibilities and an immediate decision is required between transmission and discarding, and to embodiments in which there is also a possibility of waiting for a short period and repeating the determination. In addition, it is noted that although in some embodiments a final decision about the current block is always made before moving to the next block, in other embodiments, a decision about the current block may be deferred and meanwhile exporter 132 handles one or more subsequent blocks.

It will be appreciated that the above described methods and apparatus are to be interpreted as including apparatus for carrying out the methods and methods of using the apparatus. It should be understood that features and/or steps described with respect to one embodiment may sometimes be used with other embodiments and that not all embodiments of the invention have all of the features and/or steps shown in a particular figure or described with respect to one of the specific embodiments. Tasks are not necessarily performed in the exact order described.

It is noted that some of the above described embodiments may include structure, acts or details of structures and acts that may not be essential to the invention and which are described as examples. Structure and acts described herein are replaceable by equivalents which perform the same function, even if the structure or acts are different, as known in the art. The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art. Therefore, the scope of the invention is limited only by the elements and limitations as used in the claims, wherein the terms “comprise,” “include,” “have” and their conjugates, shall mean, when used in the claims, “including but not necessarily limited to.”

1. A method of managing on-chip data, comprising:
collecting data from one or more collection points on a chip;
storing the collected data in a buffer;
operating an export circuit in a best effort mode, in which data from the buffer is transmitted outside the chip when possible and data from the buffer is discarded when required to keep the occupancy of the buffer within desired limits;
receiving an indication of occurrence of an event in the chip; and
operating the export circuit in an event mode in which all the data in the buffer, belonging to an event window, is transmitted to outside the chip, responsively to the received indication.

2. The method of claim 1, wherein collecting the data comprises collecting signals at an operation rate of the chip.

3. The method of claim 1, wherein storing the data comprises storing the data in blocks of a plurality of different sizes.

4. The method of claim 1, wherein storing the data comprises storing the data in blocks with respective headers indicating priorities of the blocks.

5. The method of claim 1, wherein operating the export circuit in a best effort mode comprises repeatedly considering an oldest block of data in the buffer and determining whether to transmit or discard the block at least partially based on one or more attributes of the block.

6. The method of claim 5, wherein determining whether to transmit or discard the block comprises determining within a predetermined number of clock cycles, whether to transmit or discard the block.

7. The method of claim 5, wherein determining whether to transmit or discard the block comprises determining whether to transmit or discard the block, before considering a subsequent block.

8. The method of claim 7, wherein determining whether to transmit or discard the block comprises postponing the decision for one or more of the considered blocks.

9. The method of claim 5, wherein determining whether to transmit or discard the block at least partially based on one or more attributes of the block comprises determining without considering attributes of other blocks in the buffer.

10. The method of claim 5, wherein determining whether to transmit or discard the block at least partially based on one or more attributes of the block comprises determining at least partially based on the current occupancy of the buffer and/or the current available bandwidth for transmission of blocks from the buffer.

11. The method of claim 5, wherein determining whether to transmit or discard the block comprises determining while taking into account the priority of the collection point of the data contained in the block.

12. The method of claim 1, wherein operating the export circuit in a best effort mode comprises maintaining the occupancy of the buffer at least at a minimal level, such that a data block from the buffer is not discarded before a predetermined amount of data entered the buffer after the block.

13. The method of claim 1, wherein operating the export circuit in a best effort mode comprises maintaining the occupancy of the buffer lower than a maximal level, such that in case an event of interest occurs, the buffer will be able to store enough data after the event, even if blocks are not dequeued from the buffer.

14. The method of claim 1, wherein collecting the data comprises collecting trace data.

15. The method of claim 1, wherein the data in the buffer belonging to the event window comprises all the data in the buffer at the time of the occurrence of the event.

16. The method of claim 15, wherein the data in the buffer belonging to the event window comprises data collected in the buffer after the occurrence of the event, of an amount of an empty area of the buffer at the time the event occurred.

17. The method of claim 1, comprising repeating the operating of the export circuit in the best effort mode after the data in the buffer belonging to the event window, is transmitted to outside the chip.

18. The method of claim 17, comprising generating a notification when the occupancy of the buffer returns to within the desired limits, after moving from the event mode to the best effort mode.

19. A method of managing on-chip internal trace data, comprising:
collecting internal waveform data from one or more collection points on an integrated circuit chip;
storing blocks of the collected internal waveform data in a buffer; and
operating an export circuit to repeatedly consider blocks in the buffer, to determine whether to transmit or discard the considered block.

20. The method of claim 19, wherein blocks in the buffer are not considered before a predetermined amount of data entered the buffer after the block to be considered.

21. The method of claim 19, wherein storing the trace data blocks comprises storing the data in blocks of a plurality of different sizes.

22. The method of claim 19, wherein operating the export circuit comprises determining for each block whether to transmit or discard the block based on the occupancy of the buffer and at least one attribute of the block.

23. The method of claim 22, wherein determining for each block whether to transmit or discard the block comprises determining at least partially based on an estimate of the available transmission bandwidth.

24. The method of claim 19, wherein the considered blocks are not discarded before a predetermined amount of data entered the buffer after the considered block.

25. A trace management unit on an integrated circuit, comprising:
a buffer in which internal waveform data blocks are accumulated;
a trace collection unit configured to collect and store internal waveform data blocks in the buffer; and
an export unit configured to repeatedly determine a data block to be currently handled, to determine whether to export or drop the determined currently handled data block at least partially responsively to its respective priority and to export data blocks determined to be exported.

26. The trace management unit of claim 25, wherein the export unit is configured not to discard a handled block before a predetermined amount of data entered the buffer after the handled block.

27. The trace management unit of claim 25, wherein the trace collection unit is configured to store in the buffer data blocks of different sizes.

28. The trace management unit of claim 25, wherein the buffer comprises a first-in first-out buffer, a pointer which is continually updated to point to the data block which is in the buffer for a longest period and a pointer which is continually updated to point to the first empty location in the buffer.

29. The trace management unit of claim 25, wherein the export unit is configured to repeatedly determine a data block which is in the buffer for a longest period to be the currently handled data block.

30. The trace management unit of claim 25, wherein the export unit is configured to determine whether to export or drop the determined currently handled data block, at least partially responsively to a current occupancy of the buffer.

31. The trace management unit of claim 25, wherein the export unit is configured to determine whether to export or drop the determined currently handled data block, at least partially responsively to a current availability of bandwidth for export of data blocks from the buffer.

32. The trace management unit of claim 25, wherein the export unit is configured to provide a notification when an occupancy of the buffer is within desired limits.
